(19) United States
(12) Patent Application Publication
(10) Pub. No.: US 2016/0102820 A1
(43) Pub. Date: Apr. 14, 2016

(54) OPTICAL WAVELENGTH-CONVERTING DEVICE AND ILLUMINATION SYSTEM USING SAME

(71) Applicant: DELTA ELECTRONICS, INC., Taoyuan City (TW)

(72) Inventors: Keh-Su Chang, Taoyuan City (TW); Yen-I Chou, Taoyuan City (TW); Chi Chen, Taoyuan City (TW); Jau-Shiu Chen, Taoyuan City (TW)

(21) Appl. No.: 14/876,022

(22) Filed: Oct. 6, 2015

Related U.S. Application Data
(60) Provisional application No. 62/063,144, filed on Oct. 13, 2014.

(30) Foreign Application Priority Data
May 29, 2015 (TW) 104117325

(51) Int. Cl. F21K 99/00; G02B 5/08; F21V 9/16; F21V 7/05

(52) U.S. Cl. CPC F21K 9/56; F21V 7/05; G02B 5/0816; F21V 9/16; F21Y 2101/025

(57) ABSTRACT

An optical wavelength-converting device used for converting a first waveband light includes a substrate, a phosphor layer and a composite reflection layer. The phosphor layer is disposed on the substrate for converting the first waveband light into a second waveband light. The composite reflection layer includes a first reflection layer and a second reflection layer. The first reflection layer is disposed between the substrate and the phosphor layer and adjacent to the substrate for reflecting the second waveband light, such that the second waveband light is transmitted through the phosphor layer so as to be outputted. The second reflection layer is disposed between the first reflection layer and the phosphor layer for adjusting the reflection spectrum of the first reflection layer, thereby enhancing the reflection rate of the composite reflection layer. As a result, the output efficiency of the wide-angle and wide-spectrum light is increased.

### CROSS-REFERENCE TO RELATED APPLICATION

This application claims the benefit of U.S. Provisional Application No. 62/063,144 filed on Oct. 13, 2014, and entitled “A REFLECTIVE STRUCTURE SUBSTRATE AND ITS USE ON PHOSPHOR WHEEL”, the entirety of which is hereby incorporated by reference.

### FIELD OF THE INVENTION

The present invention relates to an optical wavelength-converting device, and more particularly to an optical wavelength-converting device and an illumination system using the same.

### BACKGROUND OF THE INVENTION

In recent years, illumination technology of laser and phosphor is mainly utilized in projectors. Blue light and ultraviolet laser are used for exciting a phosphor wheel to generate color lights, and a color wheel is further used for dividing the required RGB color lights so as to be projected.

Please refer to FIG. 1. FIG. 1 schematically illustrates the structural view of a conventional reflective phosphor wheel of prior art. In general, a reflective layer 11 is disposed on a substrate 10 in a conventional reflective phosphor wheel 1, and an illuminating layer 12 combining phosphor powder 121 and colloid 122 is directly coated on the reflective layer 11. Laser L is utilized for exciting the phosphor powder 121, and the excited light E generated by the illuminating layer 12 is reflected to one side so as to be outputted by the reflective layer 11. Since the emission spectrum of the phosphor powder covers almost all of the wavelength (400 nm-700 nm) of visible light and exhibits Lambertian configuration, the design of the reflective layer 11 shall be considered over and over again. For example, to avoid the loss of large-angle incident, metallic reflectors, such like argentum (reflection rate 95%-97%) or aluminum (reflection rate 85%-93%), are utilized. However, the reflection rate of the metallic reflector is lower. The reliability of the metallic reflector must be considered because the metallic reflector is easier to be oxidized/corroded and the transition is easier to be occurred. If a higher reflection rate nearing 99% is required, a dielectric layer material is generally utilized. However, the dielectric multilayer reflection coating is much more dependent on the angle of incidence (AOI). With increase of the incident angle, the blue-shift of the reflection spectrum is occurred, and the reflection rate is probably decreased.

Please refer to FIG. 2. FIG. 2 schematically illustrates the reflection spectrum of a dielectric reflective coating with typical design. Considering the applications of the phosphor wheel, even if the incident angle is greater than 70 degrees, the reflection spectrum is still between 420 nm and 700 nm, which is the wavelength range of visible light (covers the emission spectrum of the general YAG yellow phosphor powder), and even a reflection rate greater than the silver is obtained. However, in the practical applications, the illuminating layer 12 is located on the reflective layer 11 in the structure of the conventional reflective phosphor wheel 1 shown in FIG. 1, the illuminating environment of the phosphor powder 121 is in the colloid having a refraction coefficient n between 1.4 and 1.5 but not the air environment. Please refer to FIG. 3. FIG. 3 schematically illustrates the reflection spectrum of the dielectric reflective coating shown in FIG. 2 in an incident colloid environment. As shown in FIG. 3, after considering the refraction rate of the incident colloid environment, the reflection spectrum is significantly lowered. In particular, the transmission rate of the large-angle incident light is obviously increased, causing the light leakage from the reflective layer 11 to the substrate 10 of the conventional reflective phosphor wheel 1. As a result, the output efficiency of the conventional reflective phosphor wheel 1 is decreased.

In brief, the reflective layers designed for the phosphor wheels cannot satisfy the high reflection rate requirement covering all visible light spectrum (400 nm-700 nm) and all (Angle of Incident, hereinafter “AOI”) regime (±0-90 degree(s)). There is a need of providing an optical wavelength-converting device and an illumination system using the same to obviate the drawbacks encountered from the prior art. This disclosure delivers a composite reflective layer in constructing an AOI-independent metallic reflective layer underlying a dielectric multi-layer reflector for large AOI leakage compensation.

### SUMMARY OF THE INVENTION

Some embodiments of the present invention are to provide an optical wavelength-converting device and an illumination system using the same in order to overcome at least one of the above-mentioned drawbacks encountered by the prior arts.

The present invention provides an optical wavelength-converting device and an illumination system using the same. By utilizing a composite reflection layer comprising a first reflection layer and a second reflection layer and adjusting the reflection spectrum of the first reflection layer through the second reflection layer, the reflection rate of the composite reflection layer is effectively enhanced, and the output efficiency of the larger angle wide spectrum is also enhanced.

In accordance with an aspect of the present invention, there is provided an optical wavelength-converting device used for converting a first waveband light. The optical wavelength-converting device includes a substrate, a phosphor layer and a composite reflection layer. The phosphor layer is disposed on the substrate for converting the first waveband light into a second waveband light. The composite reflection layer includes a first reflection layer and a second reflection layer. The first reflection layer is disposed between the substrate and the phosphor layer and adjacent to the substrate for reflecting the second waveband light, such that the second waveband light is transmitted through the phosphor layer so as to be outputted. The second reflection layer is disposed between the first reflection layer and the phosphor layer for adjusting the reflection spectrum of the first reflection layer, thereby enhancing the reflection rate of the composite reflection layer.

In accordance with another aspect of the present invention, there is provided an illumination system. The illumination system includes a solid-state light-emitting element and an optical wavelength-converting device. The solid-state light-emitting element is emitting a first waveband light to an optical path. The optical wavelength-converting device is disposed on the optical path. The optical wavelength-converting device includes a substrate, a phosphor layer and a composite reflection layer. The phosphor layer is disposed on the substrate for converting the first waveband light into a second waveband light. The composite reflection layer includes a first reflection layer and a second reflection layer. The first reflection layer is disposed between the substrate and the phosphor layer and adjacent to the substrate for reflecting the second waveband light, such that the second waveband light is transmitted through the phosphor layer so as to be outputted. The second reflection layer is disposed between the first reflection layer and the phosphor layer for adjusting the reflection spectrum of the first reflection layer, thereby enhancing the reflection rate of the composite reflection layer.

In accordance with another aspect of the present invention, there is provided an optical wavelength-converting device. The optical wavelength-converting device includes a substrate, a phosphor layer and a composite reflection layer. The phosphor layer is disposed on the substrate for converting a first waveband light into a second waveband light. The composite reflection layer includes a first reflection layer and a second reflection layer. The first reflection layer is disposed adjacent to the substrate. The thickness of the first reflection layer is greater than 30 nanometers, and the first reflection layer is selected from aluminum, argentum, aurum or an alloy consisting at least one of aluminum, argentum and aurum for reflecting the second waveband light, such that the second waveband light is transmitted through the phosphor layer so as to be outputted. The second reflection layer is disposed between the first reflection layer and the phosphor layer.

In accordance with another aspect of the present invention, there is provided an optical wavelength-converting device. The optical wavelength-converting device includes a substrate, a phosphor layer, a first reflection layer and a second reflection layer. The phosphor layer is disposed on the substrate for converting blue light or ultraviolet light into a light with wavelength greater than 460 nanometers. The first reflection layer is disposed adjacent to the substrate for reflecting the second waveband light, such that the second waveband light is transmitted through the phosphor layer so as to be outputted. The thickness of the first reflection layer is greater than 30 nanometers. The second reflection layer is disposed between the first reflection layer and the phosphor layer.

In accordance with another aspect of the present invention, there is provided an optical wavelength-converting device. The optical wavelength-converting device includes a substrate, a phosphor layer, a first reflection layer and a second reflection layer. The phosphor layer is disposed on the substrate for converting a first waveband light into a second waveband light. The first reflection layer is used for increasing the reflection rate of the second waveband light. The second reflection layer between the first reflection layer and the phosphor layer includes a dielectric multilayer film or a distributed Bragg reflector with design of incident angle between ±70°.

In accordance with another aspect of the present invention, there is provided an optical wavelength-converting device. The optical wavelength-converting device includes a substrate, a phosphor layer and a composite reflection layer. The phosphor layer is disposed on the substrate for converting a first waveband light into a second waveband light. The composite reflection layer is used for increasing the reflection rate of light with incident angle between ±70° and adjusting the reflection rate of at least a color light region of the second waveband light, thereby enhancing the output intensity of color light, which is transmitted through the phosphor layer, of the color light region.

In accordance with another aspect of the present invention, there is provided an optical wavelength-converting device. The optical wavelength-converting device includes a substrate, a phosphor layer, a first reflection layer and a second reflection layer. The phosphor layer is disposed on the substrate for converting a first waveband light into a second waveband light. The first reflection layer is plated and formed on the surface of the substrate for reflecting the second waveband light, such that the second waveband light is transmitted through the phosphor layer so as to be outputted. The second reflection layer is adhered on the first reflection layer and disposed between the first reflection layer and the phosphor layer.

In accordance with another aspect of the present invention, there is provided an optical wavelength-converting device. The optical wavelength-converting device includes a substrate, a phosphor layer, a first reflection layer, a second reflection layer and an adhesion layer. The phosphor layer is disposed on the substrate for converting a first waveband light into a second waveband light. The first reflection layer is used for reflecting the second waveband light, such that the second waveband light is transmitted through the phosphor layer so as to be outputted. The second reflection layer is adhered on the first reflection layer and disposed between the first reflection layer and the phosphor layer. The adhesion layer is disposed between the first reflection layer and the substrate. The adhesion layer is made of metal material.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the structural view of a conventional reflective phosphor wheel of prior art;

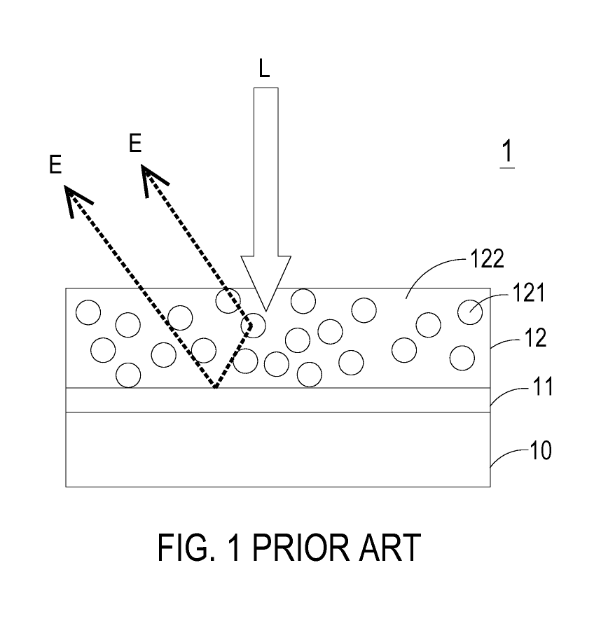

FIG. 2 schematically illustrates the reflection spectrum of a dielectric reflective coating with typical design;

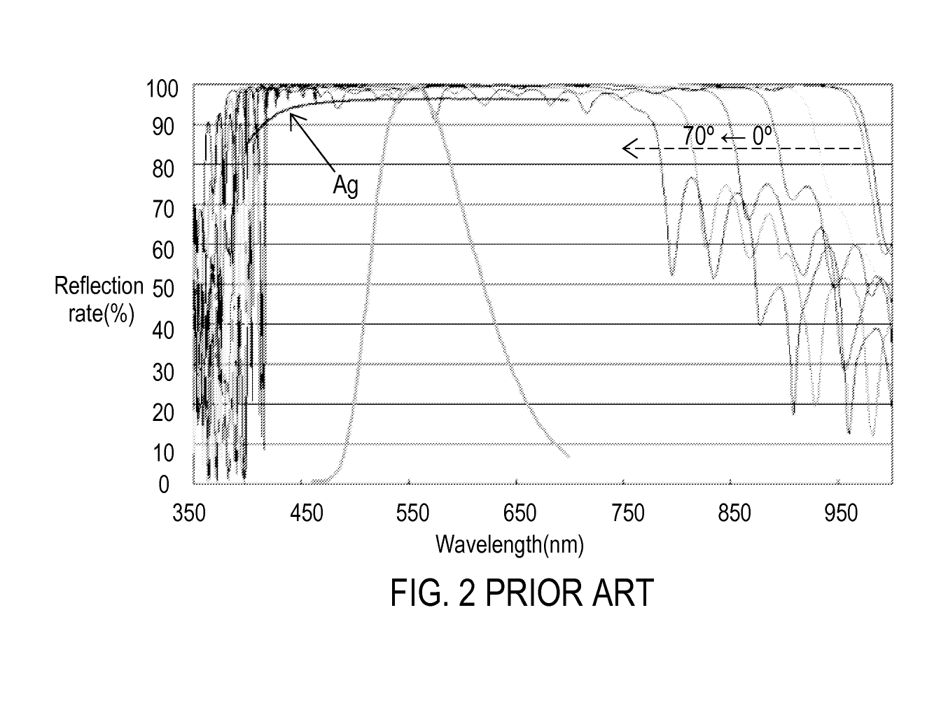

FIG. 3 schematically illustrates the reflection spectrum of the dielectric reflective coating shown in FIG. 2 in an incident colloid environment;

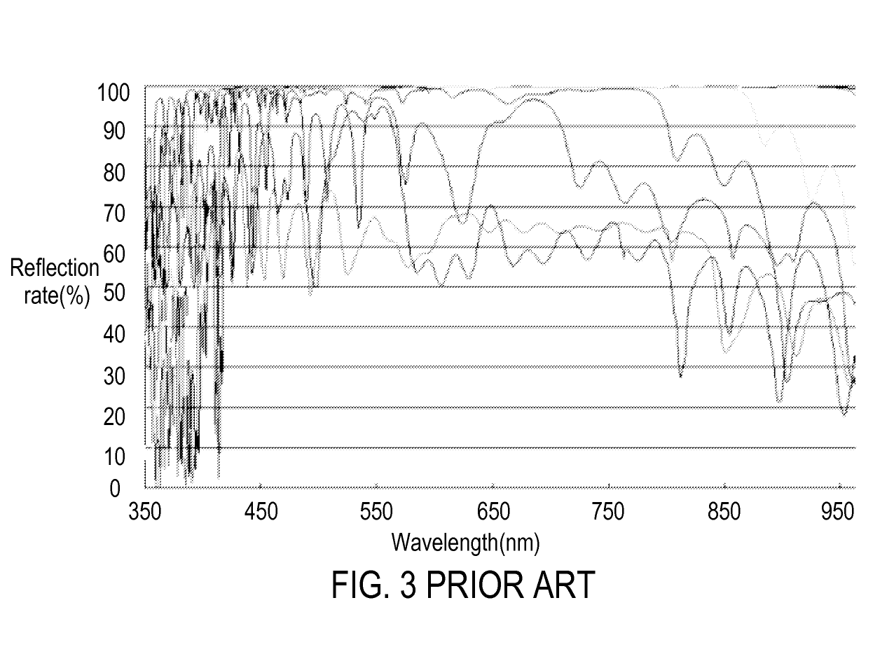

FIG. 4 schematically illustrates the configuration of an illumination system according to an embodiment of the present invention;

FIG. 5 schematically illustrates the structural view of an optical wavelength-converting device according to an embodiment of the present invention; and

FIG. 6 schematically illustrates the reflection spectrum of a composite reflection layer of the optical wavelength-converting device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

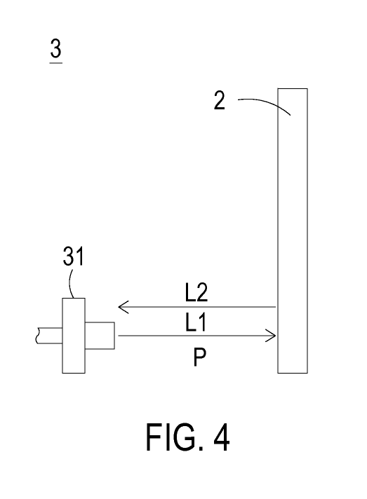

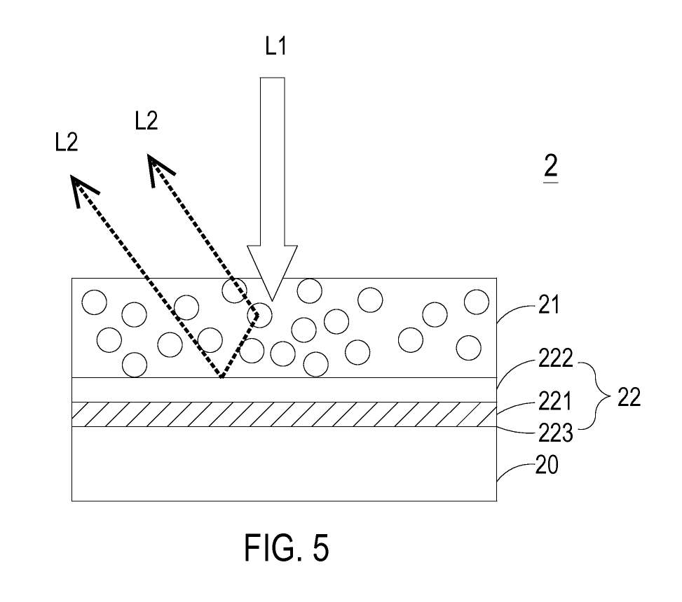

Please refer to FIG. 4 and FIG. 5. FIG. 4 schematically illustrates the configuration of an illumination system according to an embodiment of the present invention. FIG. 5 schematically illustrates the structural view of an optical wavelength-converting device according to an embodiment of the present invention. As shown in FIG. 4 and FIG. 5, an optical wavelength-converting device 2 of the present invention is used for converting a first waveband light L1, which is emitted by a solid-state light-emitting element 31 of an illumination system 3. The solid-state light-emitting element 31 is not limited to a laser light-emitting element, and is configured for emitting the first waveband light L1 to an optical path P. The optical wavelength-converting device 2 is not limited to a phosphor wheel or a phosphor plate, and is disposed on the optical path P for converting the first waveband light L1.

In some embodiments, the optical wavelength-converting device 2 includes a substrate 20, a phosphor layer 21 and a composite reflection layer 22. The phosphor layer 21 is disposed on the substrate 20 for converting the first waveband light L1 into a second waveband light L2. The composite reflection layer 22 includes a first reflection layer 221 and a second reflection layer 222. The first reflection layer 221 is disposed between the substrate 20 and the phosphor layer 21 and adjacent to the substrate 20 for reflecting the second waveband light L2, such that the second waveband light is transmitted through the phosphor layer 21 so as to be outputted. The second reflection layer 222 is disposed between the first reflection layer 221 and the phosphor layer 21 for adjusting the reflection spectrum of the first reflection layer 221, thereby enhancing the reflection rate of the composite reflection layer 22.

In some embodiments, the first reflection layer 221 is plated and formed on the surface of the substrate 20, and the second reflection layer 222 is adhered on the first reflection layer 221. In some embodiments, the composite reflection layer 22 further includes an adhesion layer 223. The adhesion layer 223 is disposed between the first reflection layer 221 and the substrate 20. The adhesion layer 223 is a titanium adhesion layer or a chromium adhesion layer.

In addition, the first reflection layer 221 of the composite reflection layer 22 of the optical wavelength-converting device 2 of the present invention is preferably a metallic reflection layer, and the second reflection layer 222 is preferably a physical vacuum coated dielectric reflection multilayer, but not limited thereto. The first reflection layer 221 is plated and made of aluminum, argentum or an alloy of aluminum or argentum to increase the reflection rate of visible light. Furthermore, since aurum is excellent for reflecting the infrared light, the first reflection layer 221 may also be plated and made of aurum to increase the reflection rate of visible light and infrared light with incident angle between ±70°. In brief, the first reflection layer 221 is selected from aluminum, argentum, aurum or an alloy consisting at least one of aluminum, argentum and aurum for meeting the practical demands. In some embodiments, the thickness of the first reflection layer 221 is greater than 30 nanometers.

The second reflection layer 222 includes a dielectric multilayer film, and the stacks of layers of the dielectric multilayer film are at least 3, and are preferably 7, with an incident angle design within ±70° (i.e. totally 140°), but not limited thereto. The stacks of layers of the dielectric multilayer film may be adjusted for meeting the practical demands, thereby optimizing the adjustment of the reflection spectrum of the first reflection layer 221, in which the present invention teaches. In some embodiments, the second reflection layer 222 is a distributed Bragg reflector (DBR), but not limited herein.

In some embodiments, the first waveband light L1 emitted by the solid-state light-emitting element 31 of the illumination system 3 is blue light or ultraviolet light, and the converted second waveband light L2 is the light with wavelength greater than 460 nanometers. The second reflection layer 222 is configured to adjust the reflection spectrum of the first reflection layer 221 in regard to the light with wavelength greater than 600 nanometers (i.e. red light), thereby enhancing the reflection rate of red light of the composite reflection layer 22. In some embodiments, the second reflection layer 222 is configured to adjust the light with desired wavelength greater than 500 nanometers (i.e. green light).

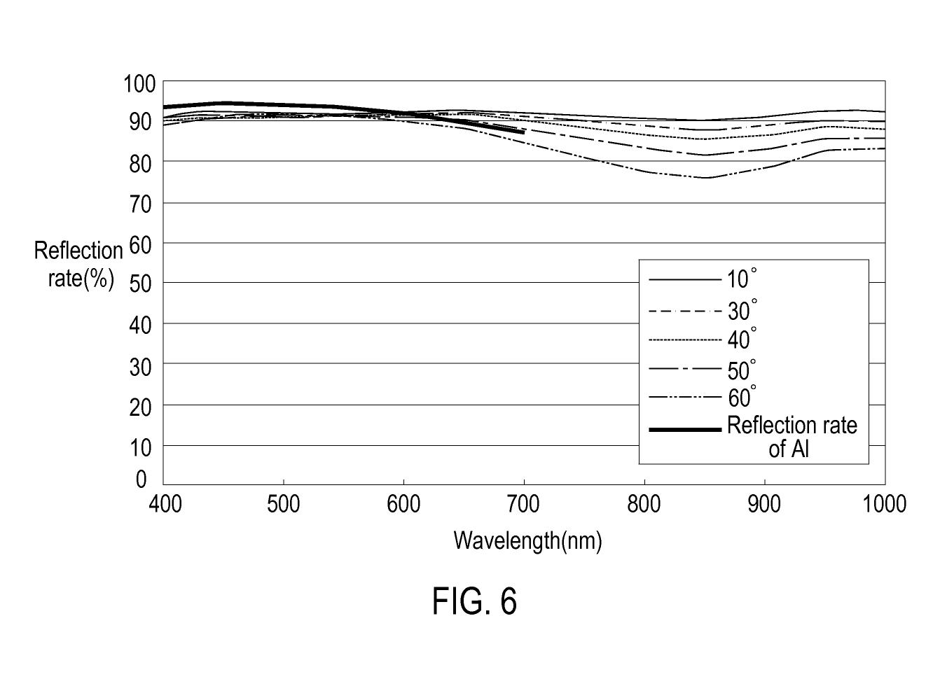

Please refer to FIG. 5, FIG. 6 and the following Table I. FIG. 6 schematically illustrates the reflection spectrum of a composite reflection layer of the optical wavelength-converting device according to an embodiment of the present invention. This embodiment emphasizes on the red light wavelength regime (>600 nm). It is worthy to note that the present disclosure can also be utilized for increasing the reflection rate of the green light wavelength regime (>500 nm). Table I illustrates the output of yellow light, green light and red light of the aluminum reflective layer of prior art, the dielectric reflective coating of prior art, and the composite reflection layer of the present invention. It should be noted that Table I is illustrated based on the output of the aluminum reflective layer of prior art.

TABLE I

| | | Dielectric | Composite |
|---|---|---|---|
| | Aluminum | reflective | reflection |
| | reflective layer | coating | layer |
| Output of | 100.0% | 98.2% | 102.4% |
| yellow light | | | |
| (460-700 nm) | | | |
| Output of | 100.0% | 96.8% | 101.7% |
| green light | | | |
| (460-580 nm) | | | |
| Output of | 100.0% | 100.7% | 103.5% |
| red light | | | |
| (490-700 nm) | | | |

As shown in FIG. 5, FIG. 6 and Table I, the reflection rate of the composite reflection layer 22 of the optical wavelength-converting device 2 of the present invention at large-angle (about 60 degrees) and wavelength between 400-700 nanometers still maintains 80% above. Meanwhile, by the composite reflection layer 22, the output of yellow light is enhanced to 102.4%, thereby enhancing the output efficiency. The output of green light and the output of red light are increased 1.7% and 3.5% in comparison with the aluminum reflective layer of prior art, respectively.

Furthermore, by the design of the composite reflection layer 22, the reflection spectrum of the first reflection layer 221 can be adjusted by the second reflection layer 222, and further the reflection rate of every color light region can be adjusted, thereby enhancing the output of the color light that is desired to be enhanced. Please refer to Table I, Table II and Table III. Table II and Table III illustrate the reflection rates of the aluminum reflective layer of prior art and the composite reflection layer of the present invention in regard to every color light in different embodiments.

TABLE II

| | | Composite |
|---|---|---|
| | Aluminum | reflection |
| | reflective layer | layer |
| Reflection rate | 100.0% | 100.2% |
| of yellow light | | |
| (460-700 nm) | | |
| Reflection rate | 100.0% | 97.5% |
| of green light | | |
| (460-580 nm) | | |
| Reflection rate | 100.0% | 104.5% |
| of red light | | |
| (490-700 nm) | | |

TABLE III

| | | Composite |
|---|---|---|
| | Aluminum | reflection |
| | reflective layer | layer |
| Reflection rate | 100.0% | 106.1% |
| of yellow light | | |
| (460-700 nm) | | |
| Reflection rate | 100.0% | 102.3% |
| of green light | | |
| (460-580 nm) | | |
| Reflection rate | 100.0% | 111.9% |
| of red light | | |
| (490-700 nm) | | |

In conclusion of Table I, Table II and Table III, by changing the configuration of the composite reflection layer 22 of the optical wavelength-converting device 2 of the present invention, the output luminance of red light is enhanced from 103.5% to 111.9% by the adjustment of the composite reflection layer 22. In other words, the reflection rate of red light of the reflection layer 22 is increased from 84%-92.5% to 95%-97%, which is beneficial to the color configuration of the projector. This embodiment clearly describes that the configuration of the composite reflection layer 22 can be changed for enhancing the output luminance of red light (>600 nm). Certainly, the configuration of the composite reflection layer 22 can be changed for enhancing the output luminance of green light (>500 nm).

From the above description, the present invention provides an optical wavelength-converting device and an illumination system using the same in order to overcome at least one of the above-mentioned drawbacks encountered by the prior arts. By utilizing a composite reflection layer comprising a first reflection layer and a second reflection layer and adjusting the reflection spectrum of the first reflection layer through the second reflection layer, the reflection rate of the composite reflection layer is effectively enhanced, and the output efficiency of the larger angle wide spectrum is also enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical wavelength-converting device used for converting a first waveband light, comprising:
a substrate;
a phosphor layer disposed on the substrate for converting the first waveband light into a second waveband light; and
a composite reflection layer comprising:
a first reflection layer disposed between the substrate and the phosphor layer and adjacent to the substrate for reflecting the second waveband light, such that the second waveband light is transmitted through the phosphor layer so as to be outputted; and
a second reflection layer disposed between the first reflection layer and the phosphor layer for adjusting the reflection spectrum of the first reflection layer, thereby enhancing the reflection rate of the composite reflection layer.

2. The optical wavelength-converting device according to claim 1, wherein the composite reflection layer further comprises an adhesion layer disposed between the first reflection layer and the substrate, and the adhesion layer is a titanium adhesion layer or a chromium adhesion layer.

3. The optical wavelength-converting device according to claim 1, wherein the first waveband light is blue light or ultraviolet light, and the second waveband light is the light with wavelength greater than 460 nanometers.

4. The optical wavelength-converting device according to claim 1, wherein the second reflection layer is configured to adjust the reflection spectrum of the first reflection layer in regard to the light with wavelength greater than 500 nanometers, and the green light reflection rate of the composite reflection layer is increased at least 1.7% by the second reflection layer.

5. The optical wavelength-converting device according to claim 1, wherein the second reflection layer is configured to adjust the reflection spectrum of the first reflection layer in regard to the light with wavelength greater than 600 nanometers, and the red light reflection rate of the composite reflection layer is increased at least 3.5% by the second reflection layer.

6. The optical wavelength-converting device according to claim 1, wherein the first reflection layer is a metallic reflection layer, and the second reflection layer is a dielectric reflection multilayer.

7. The optical wavelength-converting device according to claim 6, wherein the first reflection layer is plated and made of aluminum, argentum or an alloy of aluminum or argentum.

8. The optical wavelength-converting device according to claim 6, wherein the first reflection layer is plated and made of aurum.

9. The optical wavelength-converting device according to claim 6, wherein the thickness of the first reflection layer is greater than 30 nanometers.

10. The optical wavelength-converting device according to claim 6, wherein the second reflection layer comprises a dielectric multilayer film with the reflection rate of visible light and infrared light within incident angle between ±70° and the stacks of layers of the dielectric multilayer film are at least 3.

11. The optical wavelength-converting device according to claim 1, wherein the second reflection layer is a distributed Bragg reflector (DBR).

12. An illumination system, comprising:
a solid-state light-emitting element emitting a first waveband light to an optical path; and
an optical wavelength-converting device disposed on the optical path, comprising:
a substrate;
a phosphor layer disposed on the substrate for converting the first waveband light into a second waveband light; and
a composite reflection layer comprising:
a first reflection layer disposed between the substrate and the phosphor layer and adjacent to the substrate for reflecting the second waveband light, such that the second waveband light is transmitted through the phosphor layer so as to be outputted; and
a second reflection layer disposed between the first reflection layer and the phosphor layer for adjusting the reflection spectrum of the first reflection layer, thereby enhancing the reflection rate of the composite reflection layer.

13. An optical wavelength-converting device, comprising:
a substrate;
a phosphor layer disposed on the substrate for converting a first waveband light into a second waveband light; and
a composite reflection layer comprising:
a first reflection layer disposed adjacent to the substrate, wherein the thickness of the first reflection layer is greater than 30 nanometers, and the first reflection layer is selected from aluminum, argentum, aurum or an alloy consisting at least one of aluminum, argentum and aurum for reflecting the second waveband light, such that the second waveband light is transmitted through the phosphor layer so as to be outputted; and
a second reflection layer disposed between the first reflection layer and the phosphor layer.

14. An optical wavelength-converting device, comprising:
a substrate;
a phosphor layer disposed on the substrate for converting blue light or ultraviolet light into a light with wavelength greater than 460 nanometers;
a first reflection layer disposed adjacent to the substrate for reflecting the second waveband light, such that the second waveband light is transmitted through the phosphor layer so as to be outputted, wherein the thickness of the first reflection layer is greater than 30 nanometers; and
a second reflection layer disposed between the first reflection layer and the phosphor layer.

15. An optical wavelength-converting device, comprising:
a substrate;
a phosphor layer disposed on the substrate for converting a first waveband light into a second waveband light;
a first reflection layer for increasing the reflection rate of the second waveband light; and
a second reflection layer between the first reflection layer and the phosphor layer comprising a dielectric multilayer film or a distributed Bragg reflector with incident angle between ±70°.

16. An optical wavelength-converting device, comprising:
a substrate;
a phosphor layer disposed on the substrate for converting a first waveband light into a second waveband light; and
a composite reflection layer for increasing the reflection rate of light with incident angle between ±70° and adjusting the reflection rate of at least a color light region of the second waveband light, thereby enhancing the output intensity of color light, which is transmitted through the phosphor layer, of the color light region.

17. An optical wavelength-converting device, comprising:
a substrate;
a phosphor layer disposed on the substrate for converting a first waveband light into a second waveband light;
a first reflection layer plated and formed on the surface of the substrate for reflecting the second waveband light, such that the second waveband light is transmitted through the phosphor layer so as to be outputted; and
a second reflection layer adhered on the first reflection layer and disposed between the first reflection layer and the phosphor layer.

18. An optical wavelength-converting device, comprising:
a substrate;
a phosphor layer disposed on the substrate for converting a first waveband light into a second waveband light;
a first reflection layer for reflecting the second waveband light, such that the second waveband light is transmitted through the phosphor layer so as to be outputted;
a second reflection layer adhered on the first reflection layer and disposed between the first reflection layer and the phosphor layer; and
an adhesion layer disposed between the first reflection layer and the substrate, wherein the adhesion layer is made of metal material.
